(19) United States
(12) Patent Application Publication
(10) Pub. No.: US 2021/0248645 A1
(43) Pub. Date: Aug. 12, 2021

(54) ADVERTISING VIA A LIVE EVENT WAGERING PLATFORM

(71) Applicant: AdrenalineIP, Washington, DC (US)

(72) Inventors: Casey Alexander HUKE, Washington, DC (US); John CRONIN, Jericho, VT (US); Michael BAKER, Georgie, VT (US); Joseph BODKIN, Quincy, MA (US)

(73) Assignee: AdrenalineIP, Washington, DC (US)

(21) Appl. No.: 17/085,110

(22) Filed: Oct. 30, 2020

Related U.S. Application Data
(60) Provisional application No. 62/971,335, filed on Feb. 7, 2020.

(51) Int. Cl. G06Q 30/02; G06Q 50/34; G07F 17/32

(52) U.S. Cl. CPC G06Q 30/0269; G06Q 30/0261; G06Q 30/0273; G06Q 50/34; G07F 17/3288; G06Q 30/0276

(57) ABSTRACT

A wagering platform which matches data provided by an advertiser to situational data at a live event to deliver ads to a bettor by receiving data from an advertiser including advertisement content, conditions under which the advertisement should be delivered, and a schedule of live events during which the advertisement should be delivered to a bettor and saving the data to an advertisement database. The data in the advertisement database is compared against data from a live event, sensor and interaction data collected by a user device used by a bettor, and demographics and behavioral data relevant to the bettor can be used to identify an advertisement matching the present conditions, and further deliver the identified advertisement to the bettor.

### FIELD

The present disclosure is generally related to delivering advertisements, particularly via a wagering platform at a live event.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Traditional advertisements required maximum exposure to see an adequate return on investment. With the advent of digital marketing, it has become possible to target individuals instead of groups of people, however the amount of personalized information required to achieve this is difficult to obtain, as is determining the timing during which to deliver advertisements.

Live events often rely on passive advertisements, traditionally via advertisements which are placed on uniforms, on billboards within stadiums and even in the naming of stadiums themselves. These advertisements are largely inefficient as they are only relevant to a segment of the individuals present and while they can be changed during a live event, the still suffer the same inability to be relevant to each individual present.

Live events often involve spectators who are emotionally involved with the event itself, such as when the live event is a sporting event. Typically, spectators are emotionally invested in one of the teams and therefore may be more likely to be influenced by an advertisement depending on how events unfold, however these experiences vary widely depending on the person, requiring a personalized means of delivery for advertisements to be most effective.

Advertisements have an improved return on investment if they are targeted towards the individuals most likely to be influenced by them. This can be further improved by also delivered to an individual the most appropriate time.

### SUMMARY

The embodiments relate to a method and system for providing content. One embodiment includes a method for delivering advertisements to a bettor who is wagering on a live event via a wagering platform, including providing plays during a live event sports game, receiving advertisement content to be displayed via the wagering platform, receiving at least one condition to be met before displaying the advertisement content, relating the at least one condition to be met to at least one advertisement content, using live event data to determine a play, upon the occurrence of a play, matching the at least one condition to be met and the associated advertisement content, and displaying the advertisement content to the bettor.

Another exemplary embodiment includes a method of displaying content, including accessing a wagering platform, displaying one or more live events on which wagers may be placed, displaying one or more wagers for a live event; displaying information about a play in the live event; displaying an advertisement that is related to one or more conditions associated with at least one of the live event and data from the wagering platform.

Another exemplary embodiment provides a system for providing and displaying content, that can include a user device; a live event; a content database; and a wagering platform, where the user device accesses the wagering platform and provides wagering capabilities and the wagering platform accesses the content database in response to at least one condition being met, the at least one condition being met comprising at least one of an occurrence in the live event, a wager placed on the user device through the wagering platform, a result of a wager placed on the user device placed through the wagering platform, and a location of the user device.

### BRIEF DESCRIPTIONS OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates an advertising via a live event wagering platform, according to an embodiment.

FIG. 2 illustrates a base module, according to an embodiment.

FIG. 3 illustrates an advertiser module, according to an embodiment.

FIG. 4 illustrates an advertisement database, according to an embodiment.

FIG. 5 illustrates a bettor interaction database, according to an embodiment.

FIG. 6 illustrates a bettor information database, according to an embodiment.

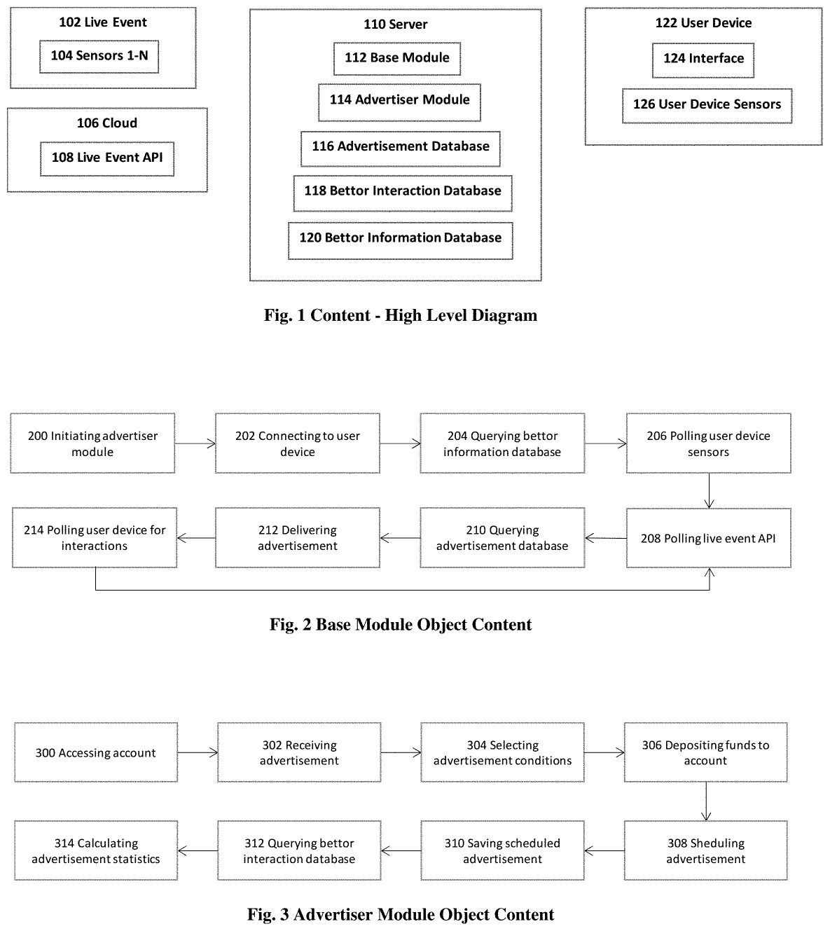

### DETAILED DESCRIPTION

Aspects of the present invention are disclosed in the following description and related figures directed to specific embodiments of the invention. Those of ordinary skill in the art will recognize that alternate embodiments may be devised without departing from the spirit or the scope of the claims. Additionally, well-known elements of exemplary embodiments of the invention will not be described in detail or will be omitted so as not to obscure the relevant details of the invention

As used herein, the word exemplary means serving as an example, instance or illustration. The embodiments described herein are not limiting, but rather are exemplary only. It should be understood that the described embodiments are not necessarily to be construed as preferred or advantageous over other embodiments. Moreover, the terms embodiments of the invention, embodiments or invention do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, a computer configured to perform the described action.

With respect to the embodiments, a summary of terminology used herein is provided.

An action refers to a specific play or specific movement in a sporting event. For example, an action may determine which players were involved during a sporting event. In some embodiments, an action may be a throw, shot, pass, swing, kick, hit, performed by a participant in a sporting event. In some embodiments, an action may be a strategic decision made by a participant in the sporting event such as a player, coach, management, etc. In some embodiments, an action may be a penalty, foul, or type of infraction occurring in a sporting event. In some embodiments, an action may include the participants of the sporting event. In some embodiments, an action may include beginning events of sporting event, for example opening tips, coin flips, opening pitch, national anthem singers, etc. In some embodiments, a sporting event may be football, hockey, basketball, baseball, golf, tennis, soccer, cricket, rugby, MMA, boxing, swimming, skiing, snowboarding, horse racing, car racing, boat racing, cycling, wrestling, Olympic sport, eSports, etc. Actions can be integrated into the embodiments in a variety of manners.

A “bet” or “wager” is to risk something, usually a sum of money, against someone else's or an entity on the basis of the outcome of a future event, such as the results of a game or event. It may be understood that non-monetary items may be the subject of a “bet” or “wager” as well, such as points or anything else that can be quantified for a “wager” or “bet.” A bettor refers to a person who bets or wagers. A bettor may also be referred to as a user, client, or participant throughout the present invention. A “bet” or “wager” could be made for obtaining or risking a coupon or some enhancements to the sporting event, such as better seats, VIP treatment, etc. A “bet” or “wager” can be done for certain amount or for a future time. A “bet” or “wager” can be done for being able to answer a question correctly. A “bet” or “wager” can be done within a certain period of time. A “bet” or “wager” can be integrated into the embodiments in a variety of manners.

A “book” or “sportsbook” refers to a physical establishment that accepts bets on the outcome of sporting events. A “book” or “sportsbook” system enables a human working with a computer to interact, according to set of both implicit and explicit rules, in an electronically powered domain for the purpose of placing bets on the outcome of sporting event. An added game refers to an event not part of the typical menu of wagering offerings, often posted as an accommodation to patrons. A “book” or “sportsbook” can be integrated into the embodiments in a variety of manners.

To “buy points” means a player pays an additional price (more money) to receive a half-point or more in the player's favor on a point spread game. Buying points means you can move a point spread, for example up to two points in your favor. “Buy points” can be integrated into the embodiments in a variety of manners.

The “price” refers to the odds or point spread of an event. To “take the price” means betting the underdog and receiving its advantage in the point spread. “Price” can be integrated into the embodiments in a variety of manners.

“No action” means a wager in which no money is lost or won, and the original bet amount is refunded. “No action” can be integrated into the embodiments in a variety of manners.

The “sides” are the two teams or individuals participating in an event: the underdog and the favorite. The term “favorite” refers to the team considered most likely to win an event or game. The “chalk” refers to a favorite, usually a heavy favorite. Bettors who like to bet big favorites are referred to “chalk eaters” (often a derogatory term). An event or game in which the sports book has reduced its betting limits, usually because of weather or the uncertain status of injured players is referred to as a “circled game.” “Laying the points or price” means betting the favorite by giving up points. The term “dog” or “underdog” refers to the team perceived to be most likely to lose an event or game. A “longshot” also refers to a team perceived to be unlikely to win an event or game. “Sides”, “favorite”, “chalk”, “circled game”, “laying the points price”, “dog” and “underdog” can be integrated into the embodiments in a variety of manners.

The “money line” refers to the odds expressed in terms of money. With money odds, whenever there is a minus (−) the player “lays” or is “laying” that amount to win (for example $100); where there is a plus (+) the player wins that amount for every $100 wagered. A “straight bet” refers to an individual wager on a game or event that will be determined by a point spread or money line. The term “straight-up” means winning the game without any regard to the “point spread”; a “money-line” bet. “Money line”, “straight bet”, “straight-up” can be integrated into the embodiments in a variety of manners.

The “line” refers to the current odds or point spread on a particular event or game. The “point spread” refers to the margin of points in which the favored team must win an event by to “cover the spread.” To “cover” means winning by more than the “point spread”. A handicap of the “point spread” value is given to the favorite team so bettors can choose sides at equal odds. “Cover the spread” means that a favorite win an event with the handicap considered or the underdog wins with additional points. To “push” refers to when the event or game ends with no winner or loser for wagering purposes, a tie for wagering purposes. A “tie” is a wager in which no money is lost or won because the teams' scores were equal to the number of points in the given “point spread”. The “opening line” means the earliest line posted for a particular sporting event or game. The term “pick” or “pick 'em” refers to a game when neither team is favored in an event or game. “Line”, “cover the spread”, “cover”, “tie”, “pick” and “pick-em” can be integrated into the embodiments in a variety of manners.

To “middle” means to win both sides of a game; wagering on the “underdog” at one point spread and the favorite at a different point spread and winning both sides. For example, if the player bets the underdog +4½ and the favorite −3½ and the favorite wins by 4, the player has middled the book and won both bets. “Middle” can be integrated into the embodiments in a variety of manners.

Digital gaming refers to any type of electronic environment that can be controlled or manipulated by a human user for entertainment purposes. A system that enables a human and a computer to interact according to set of both implicit and explicit rules, in an electronically powered domain for the purpose of recreation or instruction. “eSports” refers to a form of sports competition using video games, or a multiplayer video game played competitively for spectators, typically by professional garners. Digital gaming and “eSports” can be integrated into the embodiments in a variety of manners.

The term event refers to a form of play, sport, contest, or game, especially one played according to rules and decided by skill, strength, or luck. In some embodiments, an event may be football, hockey, basketball, baseball, golf, tennis, soccer, cricket, rugby, MMA, boxing, swimming, skiing, snowboarding, horse racing, car racing, boat racing, cycling, wrestling, Olympic sport, etc. Event can be integrated into the embodiments in a variety of manners.

The “total” is the combined number of runs, points or goals scored by both teams during the game, including overtime. The “over” refers to a sports bet in which the player wagers that the combined point total of two teams will be more than a specified total. The “under” refers to bets that the total points scored by two teams will be less than a certain figure. “Total”, “over”, and “under” can be integrated into the embodiments in a variety of manners.

A “parlay” is a single bet that links together two or more wagers; to win the bet, the player must win all the wagers in the “parlay”. If the player loses one wager, the player loses the entire bet. However, if he wins all the wagers in the “parlay”, the player wins a higher payoff than if the player had placed the bets separately. A “round robin” is a series of parlays. A “teaser” is a type of parlay in which the point spread, or total of each individual play is adjusted. The price of moving the point spread (teasing) is lower payoff odds on winning wagers. “Parlay”, “round robin”, “teaser” can be integrated into the embodiments in a variety of manners.

A “prop bet” or “proposition bet” means a bet that focuses on the outcome of events within a given game. Props are often offered on marquee games of great interest. These include Sunday and Monday night pro football games, various high-profile college football games, major college bowl games and playoff and championship games. An example of a prop bet is “Which team will score the first touchdown?” “Prop bet” or “proposition bet” can be integrated into the embodiments in a variety of manners.

A “first-half bet” refers to a bet placed on the score in the first half of the event only and only considers the first half of the game or event. The process in which you go about placing this bet is the same process that you would use to place a full game bet, but as previously mentioned, only the first half is important to a first-half bet type of wager. A “half-time bet” refers to a bet placed on scoring in the second half of a game or event only. “First-half-bet” and “half-time-bet” can be integrated into the embodiments in a variety of manners.

A “futures bet” or “future” refers to the odds that are posted well in advance on the winner of major events, typical future bets are the Pro Football Championship, Collegiate Football Championship, the Pro Basketball Championship, the Collegiate Basketball Championship, and the Pro Baseball Championship. “Futures bet” or “future” can be integrated into the embodiments in a variety of manners.

The “listed pitchers” is specific to a baseball bet placed only if both of the pitchers scheduled to start a game actually start. If they don't, the bet is deemed “no action” and refunded. The “run line” in baseball, refers to a spread used instead of the money line. “Listed pitchers” and “no action” and “run line” can be integrated into the embodiments in a variety of manners.

The term “handle” refers to the total amount of bets taken. The term “hold” refers to the percentage the house wins. The term “juice” refers to the bookmaker's commission, most commonly the 11 to 10 bettors lay on straight point spread wagers: also known as “vigorish” or “vig”. The “limit” refers to the maximum amount accepted by the house before the odds and/or point spread are changed. “Off the board” refers to a game in which no bets are being accepted. “Handle”, “juice”, vigorish”, “vig” and “off the board” can be integrated into the embodiments in a variety of manners.

“Casinos” are a public room or building where gambling games are played. “Racino” is a building complex or grounds having a racetrack and gambling facilities for playing slot machines, blackjack, roulette, etc. “Casino” and “Racino” can be integrated into the embodiments in a variety of manners.

Customers are companies, organizations or individual that would deploy, for fees, and may be part of, of perform, various system elements or method steps in the embodiments.

Managed service user interface service is a service that can help customers (1) manage third parties, (2) develop the web, (3) do data analytics, (4) connect thru application program interfaces and (4) track and report on player behaviors. A managed service user interface can be integrated into the embodiments in a variety of manners.

Managed service risk management services are a service that assists customers with (1) very important person management, (2) business intelligence, and (3) reporting. These managed service risk management services can be integrated into the embodiments in a variety of manners.

Managed service compliance service is a service that helps customers manage (1) integrity monitoring, (2) play safety, (3) responsible gambling and (4) customer service assistance. These managed service compliance services can be integrated into the embodiments in a variety of manners.

Managed service pricing and trading service is a service that helps customers with (1) official data feeds, (2) data visualization and (3) land based, on property digital signage. These managed service pricing and trading services can be integrated into the embodiments in a variety of manners.

Managed service and technology platform are services that helps customers with (1) web hosting, (2) IT support and (3) player account platform support. These managed service and technology platform services can be integrated into the embodiments in a variety of manners.

Managed service and marketing support services are services that help customers (1) acquire and retain clients and users, (2) provide for bonusing options and (3) develop press release content generation. These managed service and marketing support services can be integrated into the embodiments in a variety of manners.

Payment processing services are those services that help customers that allow for (1) account auditing and (2) withdrawal processing to meet standards for speed and accuracy. Further, these services can provide for integration of global and local payment methods. These payment processing services can be integrated into the embodiments in a variety of manners.

Engaging promotions allow customers to treat your players to free bets, odds boosts, enhanced access and flexible cashback to boost lifetime value. Engaging promotions can be integrated into the embodiments in a variety of manners.

“Cash out” or “pay out” or “payout” allow customers to make available, on singles bets or accumulated bets with a partial cash out where each operator can control payouts by managing commission and availability at all times. The “cash out” or “pay out” or “payout” can be integrated into the embodiments in a variety of manners, including both monetary and non-monetary payouts, such as points, prizes, promotional or discount codes, and the like.

“Customized betting” allow customers to have tailored personalized betting experiences with sophisticated tracking and analysis of players' behavior. “Customized betting” can be integrated into the embodiments in a variety of manners.

Kiosks are devices that offer interactions with customers clients and users with a wide range of modular solutions for both retail and online sports gaming. Kiosks can be integrated into the embodiments in a variety of manners.

Business Applications are an integrated suite of tools for customers to manage the everyday activities that drive sales, profit, and growth, from creating and delivering actionable insights on performance to help customers to manage the sports gaming. Business Applications can be integrated into the embodiments in a variety of manners.

State based integration allows for a given sports gambling game to be modified by states in the United States or countries, based upon the state the player is in, based upon mobile phone or other geolocation identification means. State based integration can be integrated into the embodiments in a variety of manners.

Game Configurator allow for configuration of customer operators to have the opportunity to apply various chosen or newly created business rules on the game as well as to parametrize risk management. Game configurator can be integrated into the embodiments in a variety of manners.

“Fantasy sports connector” are software connectors between method steps or system elements in the embodiments that can integrate fantasy sports. Fantasy sports allow a competition in which participants select imaginary teams from among the players in a league and score points according to the actual performance of their players. For example, if a player in a fantasy sports is playing at a given real time sports, odds could be changed in the real time sports for that player.

Software as a service (or SaaS) is a method of software delivery and licensing in which software is accessed online via a subscription, rather than bought and installed on individual computers. Software as a service can be integrated into the embodiments in a variety of manners.

Synchronization of screens means synchronizing bets and results between devices, such as TV and mobile, PC and wearables. Synchronization of screens can be integrated into the embodiments in a variety of manners.

Automatic content recognition (ACR) is an identification technology to recognize content played on a media device or present in a media file. Devices containing ACR support enable users to quickly obtain additional information about the content they see without any user-based input or search efforts. To start the recognition, a short media clip (audio, video, or both) is selected. This clip could be selected from within a media file or recorded by a device. Through algorithms such as fingerprinting, information from the actual perceptual content is taken and compared to a database of reference fingerprints, each reference fingerprint corresponding to a known recorded work. A database may contain metadata about the work and associated information, including complementary media. If the fingerprint of the media clip is matched, the identification software returns the corresponding metadata to the client application. For example, during an in-play sports game a “fumble” could be recognized and at the time stamp of the event, metadata such as “fumble” could be displayed. Automatic content recognition (ACR) can be integrated into the embodiments in a variety of manners.

Joining social media means connecting an in-play sports game bet or result to a social media connection, such as a FACEBOOK® chat interaction. Joining social media can be integrated into the embodiments in a variety of manners.

Augmented reality means a technology that superimposes a computer-generated image on a user's view of the real world, thus providing a composite view. In an example of this invention, a real time view of the game can be seen and a “bet” which is a computer-generated data point is placed above the player that is bet on. Augmented reality can be integrated into the embodiments in a variety of manners.

Some embodiments of this disclosure, illustrating all its features, will now be discussed in detail. It can be understood that the embodiments are intended to be open ended in that an item or items used in the embodiments is not meant to be an exhaustive listing of such item or items, or meant to be limited to only the listed item or items.

It can be noted that as used herein and in the appended claims, the singular forms “a,” “an,” and “the” include plural references unless the context clearly dictates otherwise. Although any systems and methods similar or equivalent to those described herein can be used in the practice or testing of embodiments, only some exemplary systems and methods are now described.

This is a system for advertising via a live event wagering platform. This system includes a live event 102, for example a sporting event such as a football game, basketball game, baseball game, hockey game, tennis match, golf tournament, etc., at step 102. The system may include a plurality of sensors 104 that may be used such as motion sensors, temperature sensors, humidity sensors, cameras such as an RGB-D Camera which is a digital camera providing color (RGB) and depth information for every pixel in an image, microphones, radiofrequency receiver, a thermal imager, a radar device, a lidar device, an ultrasound device, a speaker, wearable devices etc. Also, the plurality of sensors may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball.

The system also includes a cloud 106 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance. The cloud may be communicatively coupled to server 108 which may perform real time analysis on the type of play and the result of the play. The cloud may also be synchronized with game situational data, such as the time of the game, the score, location on the field, weather conditions, and the like which may affect the choice of play utilized. For example, in other exemplary embodiments, the cloud may not receive data gathered from sensors and may, instead, receive data from an alternative data feed, such as Sports Radar. This data may be provided substantially immediately following the completion of any play and the data from this feed may be compared with a variety of team data and league data based on a variety of elements, including down, possession, score, time, team, and so forth, as described in various exemplary embodiments herein, at step 106. A live event API 108, or application program interface, for delivering data from the live event 102 to the server 110 and user device 122. The system may include a server 108 which may perform real time analysis on the type of play and the result of a play or action. The server 108 (or cloud 106) may also be synchronized with game situational data, such as the time of the game, the score, location on the field, weather conditions, and the like which may affect the choice of play utilized. For example, in other exemplary embodiments, server 108 may not receive data gathered from sensors and may, instead, receive data from an alternative data feed, such as Sports Radar. This data may be provided substantially immediately following the completion of any play and the data from this feed may be compared with a variety of team data and league data based on a variety of elements, including down, possession, score, time, team, and so forth, as described in various exemplary embodiments herein. A base module 112 which initiates an advertiser module 114 and accesses a user device 122, advertisement database 116 and bettor information database 120, and monitors a live event API 108; matching advertisement conditions from the advertisement database 116, and when the conditions are met, delivering an advertisement via an interface 124 on a user device 122. It may be appreciated that the conditions from an advertisement database 116 may include conditions related to a bettor (such as selected or determined preferences, for example based on betting history), conditions related to live action game (such as a timeout, end of playing period, or other play stoppage), or conditions related to a wager (such as placement of a wager on a time real play in a live action game, a successful wager, a losing wager, a wager placed on a certain type of play or action, a wager placed on a certain team or player, and the like. An advertiser module 114 receives an advertisement, conditions under which the advertisement is to be delivered, a deposit of funds and scheduling information, and saves the data to an advertisement database 116. An advertisement database 116 stores advertisement data including an advertisement, in the form of advertising content such as one or more images, videos, sounds or messages to be delivered. The advertisement database 116 additionally storing conditions to be met before delivering the advertisement, a deposit of funds, and a schedule of which live events 102 the advertisement can be delivered during. A bettor interaction database 118 stores data, logging interactions by a bettor with a user device 122 or the bettor's surroundings such as requesting additional information about a product featured in an advertisement or dismissing an advertisement. Alternatively, the bettor interaction database 118 storing information about purchases made by a bettor. The bettor information database 120 including data pertaining to the bettor including demographics or history data. Bettor demographics data including any of gender, date of birth or age, income, education level, occupation, race or ethnicity, marital status or homeowner status. Bettor history data including any of past bets placed or passed over, bets including at least the event bet upon, success criteria, odds, amount wagered, and the wager outcome, and optionally the live event and other parties involved (if a multiparty bet), at step 120. A user device 122 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wiimote for the WII, Nintendo WII U GAMEPAD, or Apple IPHONE. Some devices allow gesture recognition inputs through combining some of the inputs and outputs. Some devices provide for facial recognition which may be utilized as an input for different purposes including authentication and other commands. Some devices provides for voice recognition and inputs, including, e.g., Microsoft KINECT, SIRI for IPHONE by Apple, Google Now or Google Voice Search.

Additional devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also provide storage and/or an installation medium for the computing device. In still other embodiments, the computing device may provide USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fibre Channel bus, or a Thunderbolt bus. The interface(s) 124 may either accept inputs from users or provide outputs to the users, or may perform both the actions. In one case, a user can interact with the interface(s) 124 using one or more user-interactive objects and devices. The user-interactive objects and devices may include user input buttons, switches, knobs, levers, keys, trackballs, touchpads, cameras, microphones, motion sensors, heat sensors, inertial sensors, touch sensors, or a combination of the above. Further, the interface(s) 124 may either be implemented as a Command Line Interface (CLI), a Graphical User Interface (GUI), a voice interface, or a web-based user-interface. The user device 122 may include a plurality of user device sensors 126 that may be used including any of an accelerometer, tilt sensor, gyroscope, camera, thermometer, hygrometer, photocell, microphone, GPS, bluetooth, Wi-Fi or touchscreen which provide data about the user or the environment proximal the user.

Functioning of the base module will now be explained with reference to FIG. 2. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the base module. The process begins with initiating the advertiser module 114, including, prompting an advertiser to create or sign into an account, receiving an advertisement from an advertiser, the advertiser selecting conditions wherein the advertisement will be displayed when the conditions are met, depositing funds to an account to be debited when an advertisement is displayed, and receiving from the advertiser one or more dates or events during which to deliver the advertisement. The scheduled advertisement being saved to the advertisement database 116 and being made available to the base module 112, at step 200. Establishing a connection to a user device 122. In an embodiment, the user device 122 is a smartphone and the connection is established via a 5G cellular data connection, at step 202. Querying the bettor information database 120 for information about the bettor including any of demographics or history data. Demographics data including any of gender, date of birth or age, income, education level, occupation, race or ethnicity, marital status or homeowner status. History data including any of past bets placed or passed over, bets including at least the event bet upon, success criteria, odds, amount wagered, and the wager outcome. Bets data can be any of a selection of “Bet” or “wager” or “buy points” or “price” or “no action” or “favorite” or “chalk” or “circled game” or “laying the points price” or “dog” or “underdog” or “money line” or “straight bet” or “straight-up” or Line” or “cover the spread” or “cover” or “tie” or “pick” or “pick-em” or “middle” or “parlay” or “round robin” or “teaser” or “prop bet” or “first-half-bet” or “half-time-bet” or “futures bet” or “future” or “Handle” or “juice” or “vigorish” or “off the board”, at step 204. Polling user device sensors 126 to determine the location of the user device 122. The user device sensors 126 including any of GPS (global positioning system), cellular service, Bluetooth, Wi-Fi, RFID (radio frequency identification) or NFC (near field communications), and determining the location of the user device 122 using a method including any of proximity sensing, triangulation, or range finding, such that the location of the user can be determined. In an embodiment, a GPS sensor on the user device is used to determine the location of a user as being within a football stadium. In another embodiment, the Bluetooth sensor on the user device 122 is used to communication with a BLE (Bluetooth Low Energy) beacon to determine the proximity of the user device to the BLE beacon, such as within a particular section of seating within a football stadium, at step 206. Polling a live event API for data 108 from a live event 102. In an embodiment, the live event 102 is a football game, and the data collected from the live event API 108 may include plays, the results of the plays, the players involved in each play, the score and plays data resulting in score changes as well as penalties. In an embodiment, the data additionally including environmental events or conditions such as weather, venue, and lighting. Play data can be data that indicates anything about the live game, such as, but not limited to audio of visual data that indicates “actions”, “sides”, “event” data, “total” data, “listed pitchers”, specific players, whistles, fouls, touchdowns, goals, yardage, player error, etc., at step 208. Querying the advertisement database 116 for advertisements with delivery conditions matching any of bettor data from the bettor information database 120, sensor data from a user device 122, such as location, or data from a live event API 108, such as plays or environmental conditions. In an embodiment, the bettor is a 34-year-old male, sensor data from a user device 122 indicates that the bettor is in a football stadium in a section adjacent to a vendor selling beer and data collected from a live event API 108 indicates that the home team just scored a touchdown. The advertisement database 116 returning an advertisement for beer being sold at the vendor adjacent to the section in which the bettor is located because the conditions associated with the advertisement are that the advertisement is to be delivered when a touchdown is scored to anyone within two sections of the vendor selling the beer. In another embodiment, selecting an advertisement in response to a successful wager, at step 210. Delivering an advertisement to the bettor via the interface 124 on the user device 122. In an embodiment, the advertisement may include a promotion, such as a voucher for a free or discounted product. Further, the advertisement may include a method of ordering a product being advertised in the advertisement, such as including a link to an order screen, or a ‘one click’ ordering method wherein the bettor's payment information is already stored in the user device 122 allowing the bettor to place an order with as few as one interaction with the user device 122. In another embodiment, an advertisement being delivered with a real-time replay of a play, such that the advertisement immediately precedes or follows the replay or is overlaid on top of the replay, at step 212. Polling a user device 122 for interactions during and after the delivery of an advertisement and saving the interactions to the bettor interaction database 118. In an embodiment, the bettor interactions including interactions with the interface 124 including requesting additional information about the product being advertised or dismissing the advertisement. In another embodiment, the sensors on the user device 122 indicating that the user device has moved from a viewing location to a vendor location, indicating the purchase of a product. It should be noted that the base module can be made available for access, reconfiguration, modification, or control for “customers” or used for “Managed service user interface service”, “Managed service risk management services”, “Managed service compliance service”, “Managed service pricing and trading service”, “Managed service and technology platform”, “Managed service and marketing support services”, “Payment processing services”, “Engaging promotions”, “Customized betting”, “Business Applications”, “State based integration”, “Game Configurator”, “Fantasy sports connector”, “Software as a service”, “Synchronization of screens”, “Automatic content recognition (ACR)”, “Joining social media”, and “Augmented reality”, at step 214.

Functioning of the advertiser module will now be explained with reference to FIG. 3. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the advertiser module. The process begins with prompting a user to create or sign into an account to facilitate the management of advertisements to be delivered, at least in part, by a wagering platform. The account allowing the uploading of advertisements, selection of the conditions that, when met, will result in the delivery of the advertisement or promotion. The account further accepting funds intended to be used to purchase advertisements and fund other promotions, at step 300. Receiving an advertisement to be displayed to a bettor, the advertisement in the format of any of an image, video, animation, recorded or synthesized audio file or text. An advertisement may additionally include a promotion, discount, or complimentary product, service or credit which may be redeemed immediately, at a later date, at the venue, online, in a traditional restaurant, convenience or retail outlet or for delivery or in home services. In an embodiment, the advertisement is a short, 10 second video, offering the bettor a 20% discount on draft beer at the nearest concession's booth at the venue where the live event is being held which the bettor may redeem before the end of the event, at step 302. Selecting conditions under which to present the advertisement to a bettor. The conditions including any of bettor demographics or history data or live event data. Bettor demographics data include any of gender, date of birth or age, income, education level, occupation, race or ethnicity, marital status or homeowner status. Bettor history data including any of past bets placed or passed over, bets including at least the event bet upon, success criteria, odds, amount wagered, and the wager outcome, and optionally the live event and other parties involved (if a multiparty bet). Bettor history data further including interaction and engagement data such as advertisements viewed and the level of attentiveness while advertisements are delivered to the bettor via sensor data including accelerometer or tilt sensor data determining the orientation of the user device or camera data, detecting the bettor's eye gaze, or interaction with the user device input methods such as buttons, touchscreen interface or an integrated or external input device such as a keyboard, mouse, stylus or gesture control interface. Live event data including any of the live event, one or more past, present or anticipated plays, players or participants in the live event including coaches, scores, penalties or weather conditions including temperature, precipitation, UV index, air quality, humidity, wind speed and direction. In an embodiment, the conditions for the advertisement described in the previous step direct the ad to be delivered to a bettor within one minute of winning a bet on a touchdown with a temperature greater than 50 degrees Fahrenheit, at step 304. Depositing funds intended to be used to purchase advertisements or other promotions to an account. The funds to be debited from the account as advertisements or other promotions are delivered to bettors. In an embodiment, using the funds to purchase one or more views of an advertisement or the distribution of a promotion, such as a credit for a free beverage at the nearest concession both within the venue, at step 306. Scheduling at least one advertisement by selecting one or more rates from a rate table and including the maximum number of advertisement deliveries or allotting a balance of funds to be debited from according to the selected rate(s). In an embodiment, presenting a rate table to an advertiser, each rate representing the cost to deliver a unit of advertisements. A unit of advertisements may be the delivery and view of one advertisement or multiple deliveries of the same advertisement. The rate table varying based upon time, event, play and advertisement type. The rate table may further vary based upon advertisement conditions such as the weather during a live event. For example, an advertisement for a beer is scheduled to be delivered up to 1000 times when the home team earns a first down in a Monday night football game when the Patriots are playing at a rate of $20 for every 100 deliveries, and up to 200 times when the Patriots sack their opponent's quarterback at a rate of $30 for every 20 deliveries, at step 308. Saving the scheduled advertisement to the advertisement database 116. The advertisement database 116 storing the advertisement content, the conditions under which to deliver the advertisement content to a bettor, the maximum number of advertisements to be delivered and the rate to be paid in addition to the account from which to debit the funds upon delivery of the advertisement, and the live event during which to deliver the advertisement, at step 310. Querying the bettor interaction database 118 for statistics pertaining to an advertisement. In an embodiment, the query requesting interactions in response to the delivery of an advertisement for a product, such as beer for sale in the venue. The interactions including the bettor purchasing the product before leaving the venue, the bettor requesting additional information about the product via the user device, and the bettor taking no action or dismissing the advertisement, at step 312. Calculating advertisement statistics from the data retrieved from the bettor interaction database 118 and displaying the statistics to a user via an interface 124 on a user device 122. In an embodiment, dividing the number of advertisement deliveries after which the bettor purchased the product, and divide by the total number of deliveries of the advertisement to determine the conversion rate of the advertisement, and displaying the conversion rate to a user via an interface 124 on a user device 122, at step 314.

Functioning of the advertisement database will now be explained with reference to FIG. 4. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the advertisement database 116. The database including advertisement content such as images, videos, text and audio, scheduling information, such as the live event 102 during which the advertisement can be delivered, a balance of funds and a rate by which the balance will be debited from the account balance, and at least one condition, which when met, the advertisement will be delivered. The advertisement database populated by the advertiser module 114 and used by the base module 112 to deliver advertisements via an interface 124 on a user device 122, in FIG. 400.

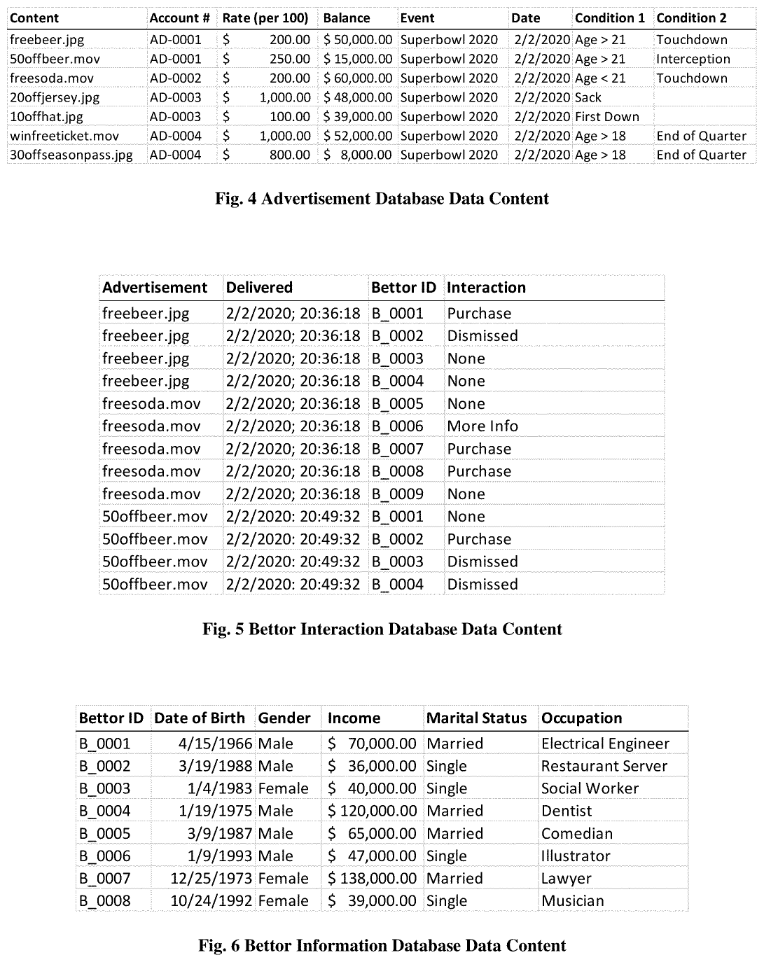

Functioning of the bettor interaction database will now be explained with reference to FIG. 5. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the bettor interaction database 118. The database including data pertaining to a delivered advertisement including information identifying the advertisement and when it was delivered, to which user device 122 the advertisement was delivered, and actions taken by a bettor following the delivery of the advertisement. The bettor interaction database 120 being populated by the base module 122 and used by the advertiser module 114 to calculate statistics relating to the advertisements, in FIG. 500.

Functioning of the bettor information database will now be explained with reference to FIG. 6. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the bettor information database 120. The database stores data about the bettor including demographics or history data. Bettor demographics data including any of gender, date of birth or age, income, education level, occupation, race or ethnicity, marital status or homeowner status. Bettor history data includes any of past bets placed or passed over, bets including at least the event bet upon, success criteria, odds, amount wagered, and the wager outcome, and optionally the live event and other parties involved (if a multiparty bet). The bettor information database 120 is populated with data provided by the bettor and is used by the base module to determine which advertisements to present to the bettor, in FIG. 600.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for delivering advertisements to a bettor who is wagering on a live event via a wagering platform, comprising:
providing plays during a live event sports game,
receiving advertisement content to be displayed via the wagering platform,
receiving at least one condition to be met before displaying the advertisement content,
relating the at least one condition to be met and at least one wagering condition on the wagering platform to be met to at least one advertisement content,
using live event data to determine a play,
upon the occurrence of a play, matching the at least one condition to be met and the associated advertisement content, and
displaying the advertisement content to the bettor.

2. The method of claim 1, further comprising correlating the at least one condition to be met is correlated to the bettor.

3. The method of claim 1, further comprising querying an advertisement database for advertisements matching the at least one condition to be met.

4. The method of claim 1, wherein the at least one condition to be met is compared with at least one of bettor data from a bettor information database, sensor data from a user device associated with the bettor, and data from a live event.

5. The method of claim 1, where the at least one condition to be met is a physical location of the bettor.

6. The method of claim 1, wherein the at least one condition to be met is a successful wager.

7. The method of claim 1, further comprising an interface to purchase the subject of an advertisement correlated to the at least one condition to be met.

8. The method of claim 1, further comprising automatically polling a bettor via an interface after the display of the advertisement.

9. The method of claim 1, further comprising displaying the advertisement in association with a video replay of the play provided via the wagering platform.

10. The method of claim 9, further comprising overlaying the advertisement over the video replay.

11. The method of claim 1, wherein the at least one condition to be met is one or more demographics of the bettor.

12. The method of claim 1, wherein the at least one condition to be met is determined by a sensor on a user device running the wagering platform.

13. A method of displaying content, comprising:
displaying a wagering platform;
displaying one or more live events on which wagers may be placed;
displaying one or more wagers for a live event;
displaying information about a play in the live event;
displaying an advertisement that is related to one or more conditions associated with at least one of the live event and data from the wagering platform.

14. The method of claim 13, further comprising displaying a replay of the play in the live event and overlaying the advertisement on the replay.

15. The method of claim 13, further comprising displaying the advertisement as a result of a determination of success of the wager.

16. A system for providing and displaying content, comprising:
a user device;
a live event;
a content database; and
a wagering platform,
wherein the user device accesses the wagering platform and provides wagering capabilities and the wagering platform accesses the content database in response to at least one condition being met, the at least one condition being met comprising at least one of a wager placed on the user device through the wagering platform, and a result of a wager placed on the user device placed through the wagering platform.

17. The system for providing and displaying content of claim 16, wherein the content is an advertisement related to the at least one condition to be met.

18. The system for providing and displaying content of claim 16, further comprising an advertiser module in the wagering platform, the advertising module capable of uploading content, modifying the content, and setting conditions under which the content is displayed on the user device.
